(19) United States
(12) Patent Application Publication
(10) Pub. No.: US 2025/0199229 A1
(43) Pub. Date: Jun. 19, 2025

(54) ELECTRONIC DEVICE AND SOFT LIGHT-GUIDE MEMBER THEREOF

(71) Applicant: Wistron NeWeb Corp., Hsinchu (TW)

(72) Inventors: Yen-Ling CHEN, Hsinchu (TW); Tung-Yi CHEN, Hsinchu (TW)

(21) Appl. No.: 18/947,392

(22) Filed: Nov. 14, 2024

(30) Foreign Application Priority Data
Dec. 14, 2023 (TW) 112148621

(51) Int. Cl. F21V 8/00

(52) U.S. Cl. CPC G02B 6/0036; G02B 6/0021; G02B 6/0065; G02B 6/009

(57) ABSTRACT

A soft light-guide member is provided. The soft light-guide member is adapted to guide a light beam provided by a light source. The soft light-guide member includes a light-entering portion and a light-emitting portion. The light-entering portion corresponds to the light source. The light beam enters the soft light-guide member via the light-entering portion, and leaves the soft light-guide member via the light-emitting portion. The soft light-guide member includes transparent silicone rubber. A diffusion microstructure is formed on the surface of the light-emitting portion.

### CROSS REFERENCE TO RELATED APPLICATIONS

This Application claims priority of Taiwan Patent Application No. 112148621, filed on Dec. 14, 2023, the entirety of which is incorporated by reference herein.

### BACKGROUND OF THE INVENTION

### Field of the Invention

The present invention relates to a soft light-guide member, and, in particular, to a soft light-guide member disposed in an electronic device.

### Description of the Related Art

Conventional light-guide members disposed in electronic devices are made of transparent plastic, and a diffusing agent needs to be added into the transparent plastic. The molding cost of the conventional light-guide member is expensive, and the mold-making is time consuming. Additionally, when a conventional light-guide member is mounted on the electronic device, a sealant is applied to the light-guide member to make it waterproof. However, the sealant tends to age due to moisture and heat, and its waterproofing properties are decreased. Conventional light-guide members have relatively high hardness. When an electronic device (for example, a vehicle electronic device) undergoes an unexpected impact, the conventional light-guide member may collide with surrounding components, generating abnormal sounds and damaging the electronic device.

### BRIEF SUMMARY OF THE INVENTION

An embodiment of the present invention provides an electronic device. The electronic device includes a housing, a light source and a soft light-guide member. The housing includes a light-emitting port. The light source provides a light beam. The soft light-guide member is disposed in the housing, wherein the soft light guide member includes a light-entering portion and a light-emitting portion, the light-entering portion corresponds to the light source. The light-emitting portion corresponds to the light-emitting port. The light beam enters the soft light-guide member via the light-entering portion, and leaves the soft light-guide member via the light-emitting portion, and a diffusion microstructure is formed on a surface of the light-emitting portion.

In another embodiment, a soft light-guide member is provided. The soft light-guide member is adapted to guide a light beam provided by a light source. The soft light-guide member includes a light-entering portion and a light-emitting portion. The light-entering portion corresponds to the light source. The light beam enters the soft light-guide member via the light-entering portion, and leaves the soft light-guide member via the light-emitting portion. The soft light-guide member includes transparent silicone rubber. A diffusion microstructure is formed on a surface of the light-emitting portion.

The soft light-guide member of the embodiments of the invention can sufficiently homogenize light beam without additional diffusing agent. The annular rib can be integrally formed on the soft light-guide member and provides waterproofness with increased reliability. The conventional sealant can be omitted. Compared with the conventional art, the mold cost of the soft light-guide member of the embodiments of the invention is lower, and the mold-making time is shorter. Additionally, the soft light-guide member of the embodiments of the invention can absorb vibration, and thus protects the surrounding elements (such as circuit board, light source and electronic components). The lifespan of the electronic device is increased, and also avoids abnormal noise.

### BRIEF DESCRIPTION OF THE DRAWINGS

The present invention can be more fully understood by reading the subsequent detailed description and examples with references made to the accompanying drawings, wherein:

FIG. 1A is a perspective view of a soft light-guide member of a first embodiment of the invention;

FIG. 1B is another perspective view of the soft light-guide member of the first embodiment of the invention;

FIG. 2A is an exploded view of an electronic device of the first embodiment of the invention;

FIG. 2B shows the details of a housing of the first embodiment of the invention;

FIG. 3 is a cross-sectional view of the electronic device of the first embodiment of the invention;

FIG. 4 is a perspective view of a soft light-guide member of a second embodiment of the invention;

FIG. 5 is cross-sectional view of the electronic device of the second embodiment of the invention; and

FIG. 6 is a perspective view of a soft light-guide member of a third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

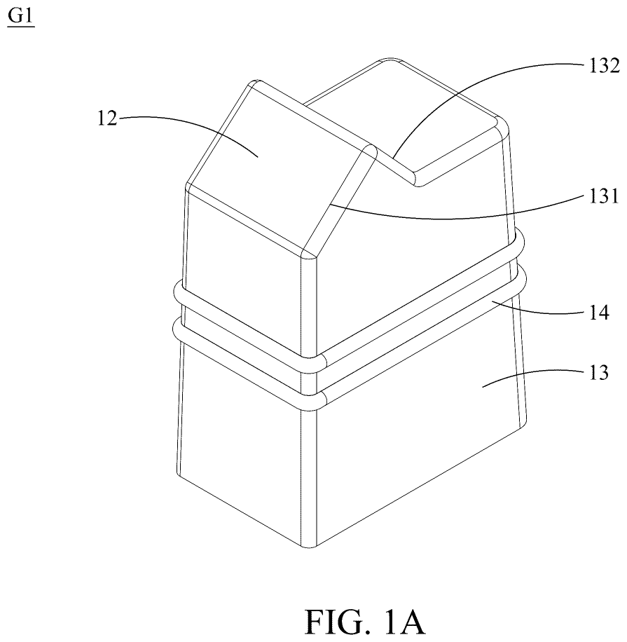

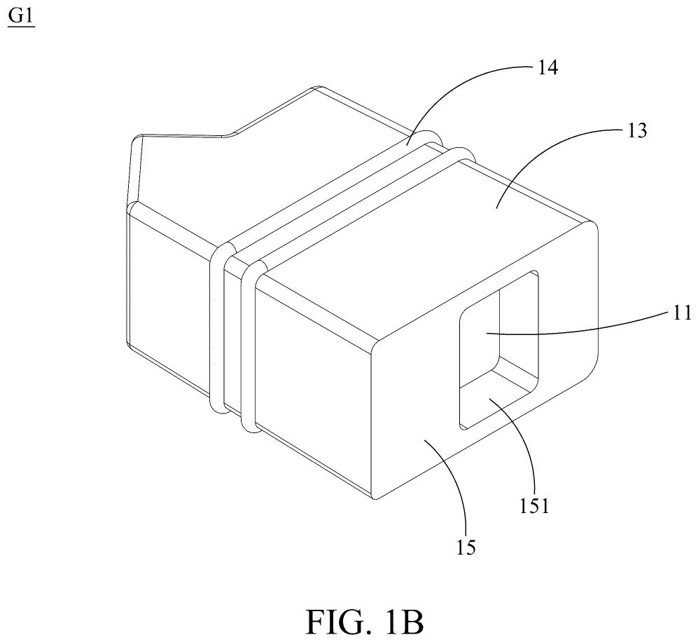

FIG. 1A is a perspective view of a soft light-guide member of a first embodiment of the invention. FIG. 1B is another perspective view of the soft light-guide member of the first embodiment of the invention. With reference to FIGS. 1A and 1B, the soft light-guide member G1 is adapted to guide a light beam (not shown) provided by a light source (not shown). The soft light-guide member G1 includes a light-entering portion 11 and a light-emitting portion 12. The light-entering portion 11 corresponds to the light source (not shown). The light beam (not shown) enters the soft light-guide member G1 via the light-entering portion 11, and leaves the soft light-guide member G1 via the light-emitting portion 12.

With reference to FIGS. 1A and 1B, in one embodiment, the soft light-guide member G1 includes transparent silicone rubber. The soft light-guide member G1 therefore has properties such as elasticity, flexibility, light transmission, and waterproofness. The disclosure is not meant to restrict the invention. In another embodiment, the soft light-guide member G1 can be made of other materials.

With reference to FIGS. 1A and 1B, in one embodiment, a diffusion microstructure is formed on a surface of the light-emitting portion 12. The diffusion microstructure can homogenize the light beam. In one embodiment, the diffusion microstructure can be a discharge flower microstructure formed by electrical discharge processing through a mold. The disclosure is not meant to restrict the invention. In another embodiment, the diffusion microstructure can also be formed by texture, sandblasting or laser processing.

With reference to FIGS. 1A and 1B, in one embodiment, the soft light-guide member G1 further includes light-guide body 13 and an annular rib 14. The annular rib 14 surrounds an outer surface of the light-guide body 13. In one embodiment, the annular rib 14 provides waterproofness. In another embodiment, the annular rib 14 reduces friction, and the soft light-guide member G1 can be easily detached from a housing of an electronic device. In one embodiment, a cross-section of the annular rib 14 is semicircular.

With reference to FIG. 1A, in one embodiment, there are two annular ribs 14. The distance between the two annular ribs 14 can be greater than 1 mm, and the strength of the mold for the soft light-guide member G1 can be therefore improved.

With reference to FIGS. 1A and 1B, in one embodiment, the light-guide body 13 further includes a first inclined surface 131 and a second inclined surface 132. The first inclined surface 131 is connected to the second inclined surface 132. The light-emitting portion 12 is located on the first inclined surface 131.

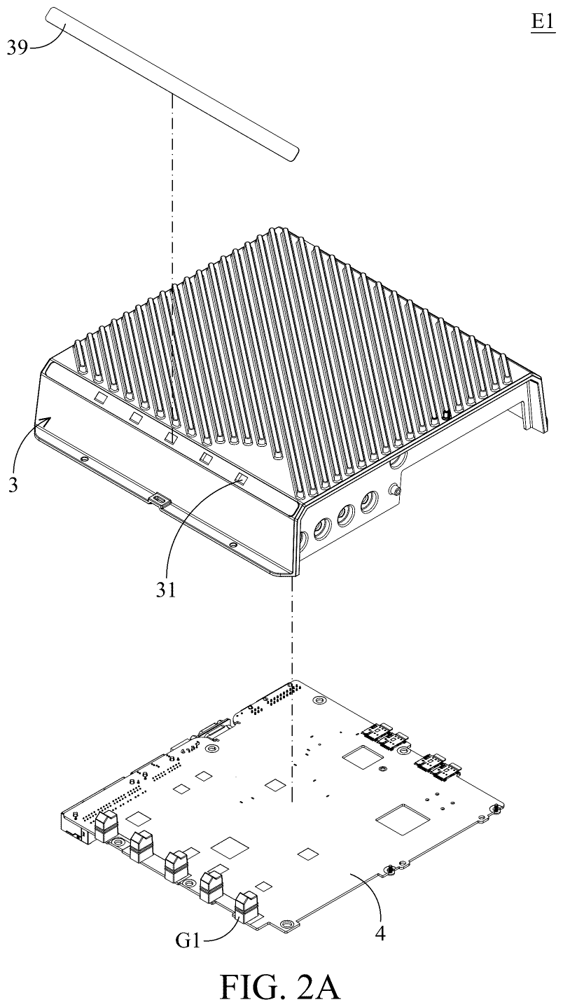

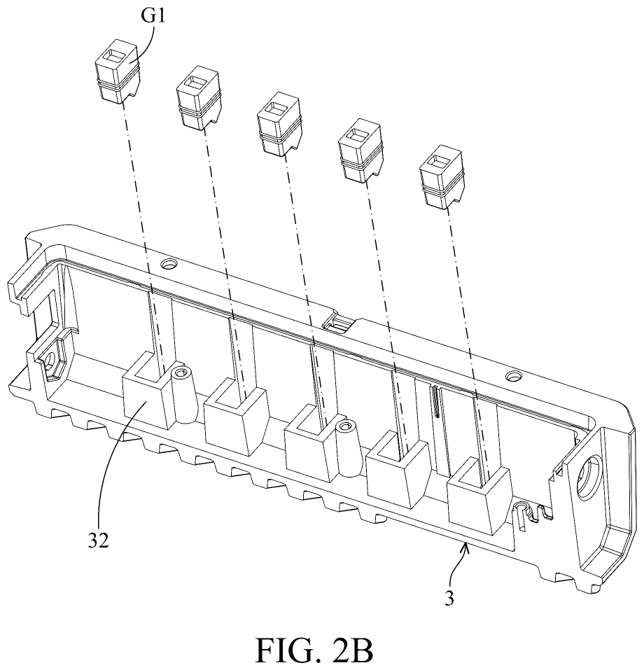

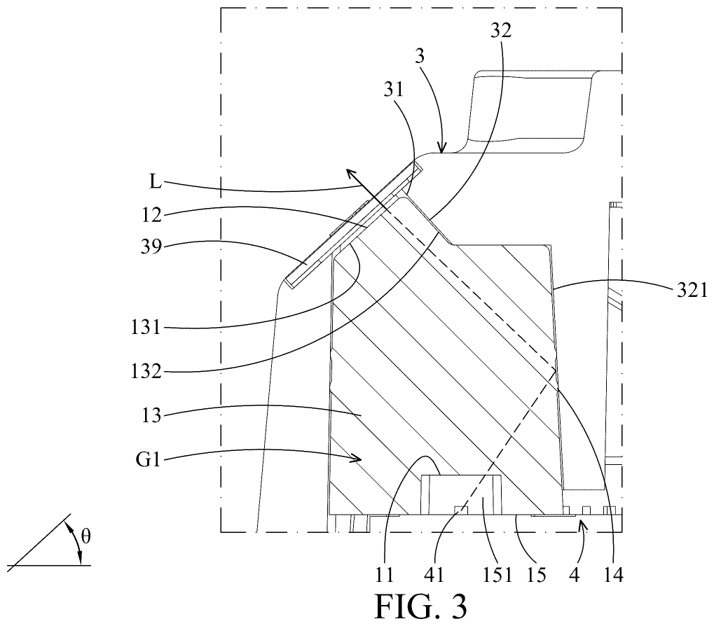

FIG. 2A is an exploded view of an electronic device of the first embodiment of the invention. FIG. 2B shows the details of a housing of the first embodiment of the invention. FIG. 3 is a cross-sectional view of the electronic device of the first embodiment of the invention. With reference to FIGS. 1A, 1B, 2A, 2B and 3, the electronic device El of the first embodiment of the invention includes a housing 3, a light source 41 and the soft light-guide member G1. The housing 3 includes a light-emitting port 31. The light source 41 provides a light beam L. The soft light-guide member G1 is disposed in the housing 3. The soft light guide member G1 includes a light-entering portion 11 and a light-emitting portion 12. The light-entering portion 11 corresponds to the light source 41. The light-emitting portion 12 corresponds to the light-emitting port 31. The light beam L enters the soft light-guide member G1 via the light-entering portion 11 and leaves the soft light-guide member G1 via the light-emitting portion 12.

With reference to FIGS. 2B and 3, in one embodiment, the housing 3 includes a compartment 32, and the soft light-guide member G1 is inserted into the compartment 32. In one embodiment, the compartment 32 restricts the soft light-guide member G1, and prevents the light beam from leaking.

With reference to FIGS. 2B and 3, in one embodiment, the electronic device E1 further includes a decoration panel 39. The decoration panel 39 covers the light-emitting port 31. The decoration panel 39 is transparent, and provides waterproof and dustproof functions.

With reference to FIGS. 2A and 3, in one embodiment, the electronic device E1 further includes a circuit board 4. The light source 41 is disposed on the circuit board 4. The soft light-guide member G1 abuts the circuit board 4. At least a portion of the soft light-guide member G1 protrudes from the compartment 32. In one embodiment, the soft light-guide member G1 abuts the circuit board 4 to provide buffer function and to prevent the circuit board 4 from unexpected impact.

With reference to FIGS. 1A, 2A and 3, in one embodiment, the compartment 32 has a compartment inner wall 321, and the annular rib 14 abuts the compartment inner wall 321.

With reference to FIGS. 1B and 3, in one embodiment, the light-guide body 13 includes a body surface 15. A recess 151 is formed on the body surface 15. The light-entering portion 11 is located in the recess 15. The light source 41 faces the recess 151. In one embodiment, the air gap between the light source 41 and the light-entering portion 11 is about 1 mm, the air gap homogenize the light beam.

With reference to FIGS. 1A and 3, in one embodiment, the first inclined surface 131 faces the light-emitting port 31, and the second inclined surface 132 abuts the compartment 32.

With reference to FIG. 3, in one embodiment, an included angle θ between the first inclined surface 131 and the body surface 15 is greater than zero degrees, and the problem of bright or dark spot is prevented.

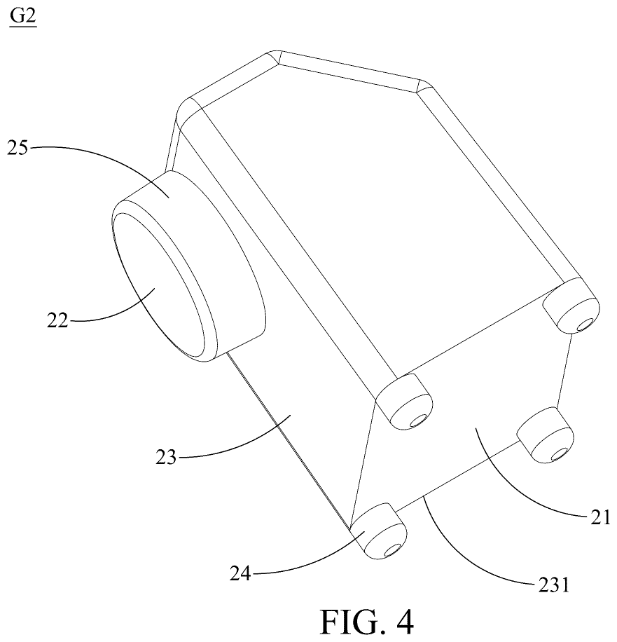

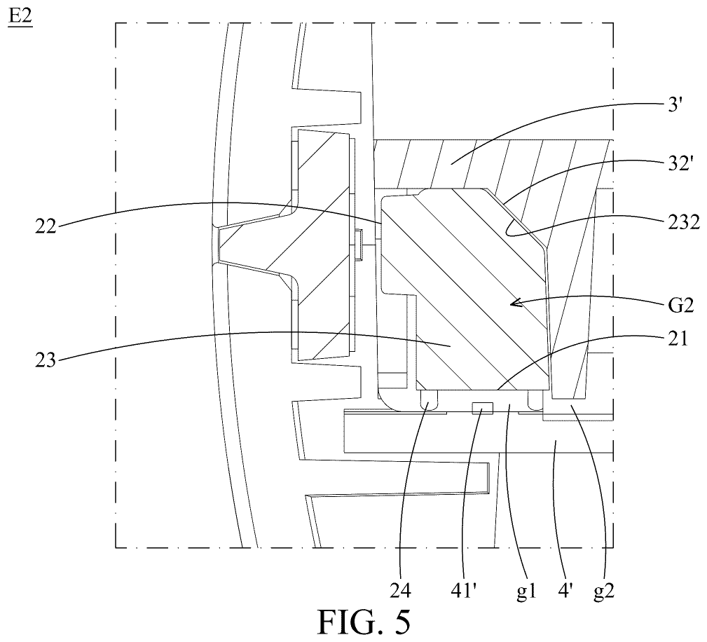

FIG. 4 is a perspective view of a soft light-guide member of a second embodiment of the invention. FIG. 5 is cross-sectional view of the electronic device of the second embodiment of the invention. With reference to FIGS. 4 and 5, the soft light-guide member G2 of the second embodiment of the invention is adapted to guide a light beam (not shown) provided by a light source 41′. The soft light-guide member G2 includes a light-entering portion 21 and a light-emitting portion 22. The light-entering portion 21 corresponds to the light source 41′. The light beam (not shown) enters the soft light-guide member G2 via the light-entering portion 21, and leaves the soft light-guide member G2 via the light-emitting portion 22.

Similar to the first embodiment, a diffusion microstructure is formed on a surface of the light-emitting portion 22. The diffusion microstructure can homogenize the light beam. In one embodiment, the diffusion microstructure can be a discharge flower microstructure formed by electrical discharge processing through a mold. The disclosure is not meant to restrict the invention. In another embodiment, the diffusion microstructure can also be formed by texture, sandblasting or laser processing.

With reference to FIG. 4, in one embodiment, the soft light-guide member G2 includes a light-guide body 23 and a plurality of stands 24. The stands 24 are disposed on a body surface 231 of the light-guide body 23. The light-entering portion 21 is located on the body surface 231. In one embodiment, the stands 24 can be cylindrical, spherical or other shapes. The disclosure is not meant to restrict the invention.

With reference to FIGS. 4 and 5, in one embodiment, the stands 24 abut a circuit board 4′ of the electronic device E2, and a first gap g1 is formed between the body surface 231 and the circuit board 4′.

With reference to FIG. 5, in one embodiment, a second gap g2 is formed between a housing 3′ and the circuit board 4′, and the first gap g1 is communicated with the second gap g2. In this embodiment, airflow passes through the first gap g1 and the second gap g2 to remove heat from the light source 41′, and the lifespan of the light source 41′ is thus increased.

With reference to FIG. 5, in one embodiment, the light-guide body 23 further includes a body-inclined surface 232, and the body-inclined surface 232 abuts the compartment 32′ of the housing 3′. The housing 3′ thus restrict the freedom of the soft light-guide member G2.

With reference to FIGS. 4 and 5, in one embodiment, the soft light-guiding member G2 includes a cylindrical portion 35. The cylindrical portion 35 is connected to the light-guide body 23. The light-emitting portion 22 is located on one end of the cylindrical portion 25.

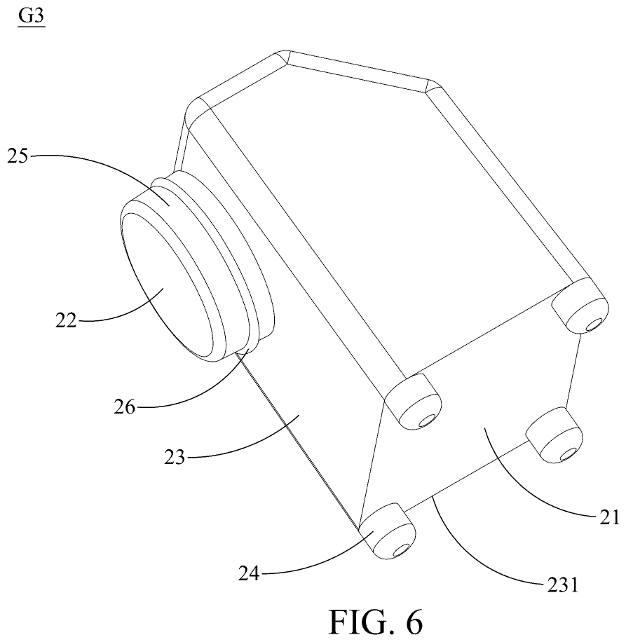

FIG. 6 is a perspective view of a soft light-guide member of a third embodiment of the invention. With reference to FIG. 6, in this embodiment, the soft light-guiding member G3 further includes an annular rib 26. The annular rib 26 surrounds an outer surface of the cylindrical portion 25. In one embodiment, the annular rib 26 provides waterproofness. In another embodiment, the annular rib 26 reduces friction, and the soft light-guide member G3 can be easily detached from the housing of the electronic device. In one embodiment, a cross-section of the annular rib 26 is semicircular.

The soft light-guide member of the embodiments of the invention can sufficiently homogenize light beam without additional diffusing agent. The annular rib can be integrally formed on the soft light-guide member and provides waterproofness with increased reliability. The conventional sealant can be omitted. Compared with the conventional art, the mold cost of the soft light-guide member of the embodiments of the invention is lower, and the mold-making time is shorter. Additionally, the soft light-guide member of the embodiments of the invention can absorb vibration, and thus protects the surrounding elements (such as circuit board, light source and electronic components). The lifespan of the electronic device is increased, and also avoids abnormal noise.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a housing, comprising a light-emitting port;
a light source, providing a light beam; and
a soft light-guide member, disposed in the housing, wherein the soft light guide member comprises a light-entering portion and a light-emitting portion, the light-entering portion corresponds to the light source, the light-emitting portion corresponds to the light-emitting port, the light beam enters the soft light-guide member via the light-entering portion, and leaves the soft light-guide member via the light-emitting portion, and a diffusion microstructure is formed on a surface of the light-emitting portion.

2. The electronic device as claimed in claim 1, wherein the soft light-guide member comprises transparent silicone rubber.

3. The electronic device as claimed in claim 1, wherein the housing comprises a compartment, and the soft light-guide member is inserted into the compartment.

4. The electronic device as claimed in claim 3, further comprising a circuit board, wherein the light source is disposed on the circuit board, the soft light-guide member abuts the circuit board, and at least a portion of the soft light-guide member protrudes from the compartment.

5. The electronic device as claimed in claim 4, wherein the soft light-guide member comprises a light-guide body and an annular rib, the annular rib surrounds an outer surface of the light-guide body, the compartment comprises a compartment inner wall, and the annular rib abuts the compartment inner wall.

6. The electronic device as claimed in claim 5, wherein the light-guide body comprises a body surface, a recess is formed on the body surface, the light-entering portion is located in the recess, and the light source faces the recess.

7. The electronic device as claimed in claim 5, wherein the light-guide body further comprises a first inclined surface and a second inclined surface, the first inclined surface is connected to the second inclined surface, the light-emitting portion is located on the first inclined surface, the first inclined surface faces the light-emitting port, and the second inclined surface abuts the compartment.

8. The electronic device as claimed in claim 7, wherein an included angle between the first inclined surface and the body surface is greater than zero degrees.

9. The electronic device as claimed in claim 4, wherein the soft light-guide member comprises a light-guide body and a plurality of stands, the stands are disposed on a body surface of the light-guide body, the light-entering portion is located on the body surface, the stands abut the circuit board, and a first gap is formed between the body surface and the circuit board.

10. The electronic device as claimed in claim 9, wherein a second gap is formed between the housing and the circuit board, and the first gap is communicated with the second gap.

11. The electronic device as claimed in claim 9, wherein the light-guide body further comprises a body-inclined surface, and the body-inclined surface abuts the compartment.

12. The electronic device as claimed in claim 9, wherein the soft light-guiding member comprises a cylindrical portion, the cylindrical portion is connected to the light-guide body, and the light-emitting portion is located on one end of the cylindrical portion.

13. The electronic device as claimed in claim 12, wherein the soft light-guiding member further comprises an annular rib, and the annular rib surrounds an outer surface of the cylindrical portion.

14. A soft light-guide member, adapted to guide a light beam provided by a light source, comprising:
a light-entering portion and a light-emitting portion, the light-entering portion corresponds to the light source, the light beam enters the soft light-guide member via the light-entering portion, and leaves the soft light-guide member via the light-emitting portion,
wherein the soft light-guide member comprises transparent silicone rubber,
wherein a diffusion microstructure is formed on a surface of the light-emitting portion.

15. The soft light-guide member as claimed in claim 14, further comprising a light-guide body and an annular rib, and the annular rib surrounds an outer surface of the light-guide body.

16. The soft light-guide member as claimed in claim 15, wherein the light-guide body further comprises a first inclined surface and a second inclined surface, the first inclined surface is connected to the second inclined surface, and the light-emitting portion is located on the first inclined surface.

17. The soft light-guide member as claimed in claim 14, further comprising a light-guide body and a plurality of stands, the stands are disposed on a body surface of the light-guide body, and the light-entering portion is located on the body surface.

18. The soft light-guide member as claimed in claim 17, further comprising a cylindrical portion and an annular rib, the cylindrical portion is connected to the light-guide body, the light-emitting portion is located on one end of the cylindrical portion, and the annular rib surrounds an outer surface of the cylindrical portion.
